(19) United States
(12) Patent Application Publication
(10) Pub. No.: US 2006/0038939 A1
(43) Pub. Date: Feb. 23, 2006

(54) Liquid crystal display device

(75) Inventor: Kuniaki Okada, Tenri-shi (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 11/208,354

(22) Filed: Aug. 19, 2005

(30) Foreign Application Priority Data
Aug. 19, 2004 (JP) 2004-239494(P)

(51) Int. Cl. G02F 1/1333

(52) U.S. Cl. 349/110

(57) ABSTRACT

A liquid crystal display device includes a reflective electrode, i.e. a first periodical structure which is a layer of light shielding material having periodical apertures, and a prism sheet, i.e. a second periodical structure, where Aₙ determined by Aₙ=2W_{L}/P_{L}·sin(nπW_{L}/P_{L})/(nπW_{L}/P_{L}) (n is a natural number) is not more than 0.05 and (2n−1)/(2·P_{L})<1/P_{P}<(2n+1)/(2 ·P_{L}) is satisfied, where P_{L} and W_{L} are the pitch and width of the apertures, respectively, and P_{P} is the pitch of the second periodical structure.

This nonprovisional application is based on Japanese Patent Application No. 2004-239494 filed with the Japan Patent Office on Aug. 19, 2004, the entire contents of which are hereby incorporated by reference.

### BACKGROUND OF THE INVENTION

1. Field of the Invention

The present invention relates to a transmissive liquid crystal display device having a backlight.

2. Description of the Background Art

A liquid crystal display device is composed of a plurality of sheet-like components such as a liquid crystal display panel and a light guide that overlie each other. A liquid crystal display panel has pixels therein arranged regularly with a certain pitch, while a light guide has structures such as grooves or low-refractive index substance, again arranged regularly with a certain pitch. Thus, overlaying these components may cause moiré fringes, which are known to occur generally when light and dark grids overlie upon each other. Such moiré fringes (hereinafter also referred to simply as “moiré ”) adversely affect the visibility of a liquid crystal display device.

An example of the techniques to solve this problem is disclosed in Japanese Patent Laying-Open No. 2000-206529. The pixel pitch, P1, and the groove pitch, P2, as in the above document, are herein referred to as pixel pitch P_{L} and groove pitch P_{P}, respectively. The technique according to the above document overlays two periodical structures, having pixel pitch P_{L} and groove pitch P_{P}, at a crossing angle, θ, such that
{2 cosθ/(2m+1)}×P_{L}≈P_{P} (1)
for any natural number m, where P_{L}>P_{P}. When this condition is satisfied, the fringe distance for a moiré takes its minimum value and thus is below the resolution of the human eye, allowing improved visibility for the human eye.

The technique described in the above-mentioned document provides that three parameters i.e. pixel pitch P_{L}, groove pitch P_{P} and crossing angle θ satisfy a certain conditional expression. Pixel pitch P_{L} is, however, determined by the size of a panel and the resolution and thus cannot be decided arbitrarily, and can take various values. Groove pitch P_{P} is very inflexible because the optimization of the groove pitch for each liquid crystal panel adds to the cost of a light guide. Consequently, an improper combination of pixel pitch P_{L} and groove pitch P_{P}, such as P_{L} being an integral multiple of P_{P} or close to it, would entail an extraordinarily large crossing angle θ for reducing moiré.

Typically, to provide a uniform in-plane distribution of outgoing light from a backlight, the pixels are disposed along a direction parallel to the direction of light advancement within a light guide plate of the backlight i.e. the groove pitch is a length along the direction of light advancement within a light guide plate of a backlight. Under this condition, the front brightness is at its maximum when the longitudinal direction of the grooves is perpendicular to the advancement of light i.e. crossing angle θ between the two periodical structures is zero. Larger crossing angle θ causes decreased front brightness, and it is thus desirable that crossing angle θ be minimized.

### SUMMARY OF THE INVENTION

An object of the present invention is to provide a liquid crystal display device with high front brightness and reduced moiré.

In an aspect of a liquid crystal display device according to the present invention, the above object may be achieved by a liquid crystal display device including: a first periodical structure which is a layer of light shielding material having periodical apertures; and a second periodical structure, where Aₙ determined by Aₙ=2W_{L}/P_{L}·sin(n πW_{L}/P_{L})/(nπW_{L}/P_{L}) (n is a natural number) is not more than 0.05 and (2n−1)/(2·P_{L})<1/P_{P}<(2n+1)/(2·P_{L}) is satisfied, where P_{L} and W_{L} are the pitch and width of the apertures, respectively, and P_{P} is the pitch of the second periodical structure.

In another aspect of a liquid crystal display device according to the present invention, the above object may be achieved by a liquid crystal display device including: a first periodical structure which is a layer of light shielding material having periodical apertures; and a second periodical structure, where nW_{L}=mP_{L} (m and n are natural numbers) and (2n−1)/(2·P_{L})<1/P_{P}<(2n+1)/(2·P_{L}) is satisfied, where P_{L} and W_{L} are the pitch and width of the apertures, respectively, and P_{P} is the pitch of the second periodical structure.

According to the present invention, a condition can be derived that effectively reduces moiré contrast for any aperture pitch, any prism pitch and any pixel aperture ratio. Thus, the crossing angle between a liquid crystal display panel and a prism sheet can be zero, allowing a high front brightness to be maintained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional view of a liquid crystal display device according to a first embodiment of the present invention.

FIG. 2 is a plan view of a liquid crystal display panel included in the liquid crystal display device according to the first embodiment of the present invention.

FIG. 3 shows an exemplary transmissivity profile T_{F} (x) for the illustration of the first embodiment of the present invention.

FIG. 4 is a graph showing a distribution of spatial frequency components for the illustration of the first embodiment of the present invention.

FIG. 5 is another exemplary transmissivity profile T_{F} (x) for the illustration of the first embodiment of the present invention.

FIG. 6 is another graph showing a distribution of spatial frequency components for the illustration of the first embodiment of the present invention.

### DESCRIPTION OF THE PREFERRED EMBODIMENTS

### First Embodiment

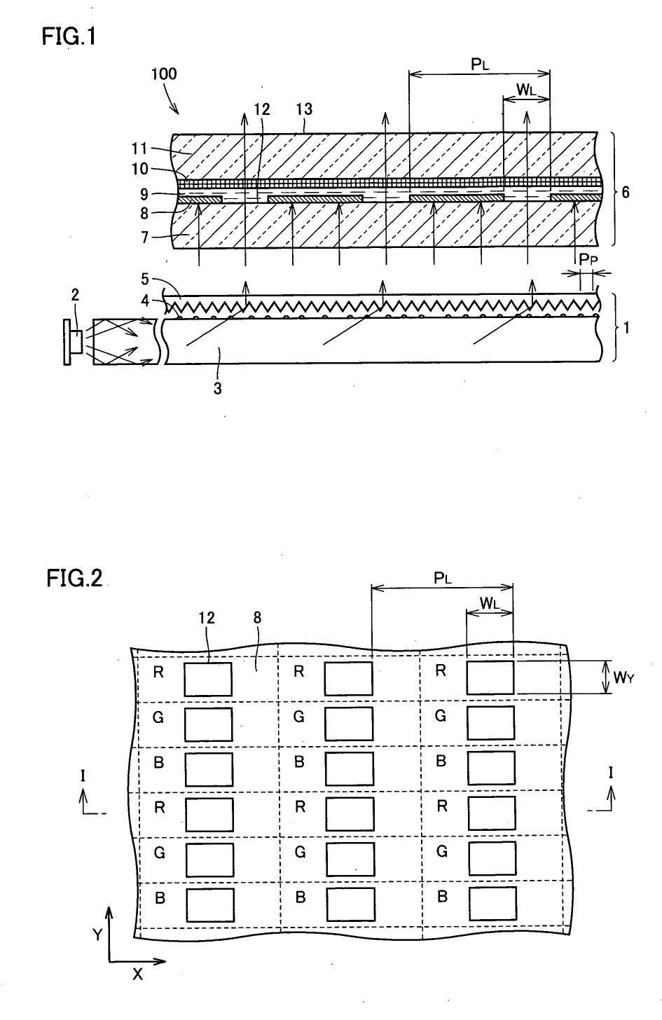

Reference is made to FIGS. 1 and 2 to describe a liquid crystal display device according to a first embodiment of the present invention. A semi-transmissive liquid crystal display device is described herein that functions as both a transmissive, as well as a reflective, liquid crystal display device. A cross sectional view of a liquid crystal display device 100 of the present embodiment is shown in FIG. 1. FIG. 2 shows in plan view how pixels of a liquid crystal display panel 6 included in liquid crystal display device 100 are arranged.

FIG. 1 corresponds to a cross sectional view in the direction of the arrow of I-I in FIG. 2. FIG. 1 only shows major components, and does not show, for example, polarizers provided on the front- and backside of liquid crystal display panel 6. Liquid crystal display device 100 includes a liquid crystal display panel 6 and a backlight 1 facing the side of liquid crystal display panel 6 opposite to viewing side 13. Backlight 1 includes a light source 2, a light guide plate 3 receiving light from light source 2 and passing it therethrough, and a prism sheet 5 inserted between light guide plate 3 and liquid crystal display panel 6 for guiding the light passing through light guide plate 3 toward liquid crystal display panel 6. Microdots 4 are formed in a random fashion on the side of light guide plate 3 through which light comes out. The light passing through light guide plate 3 leaks through microdots 4 to the outside of the light guide plate and forwarded up by prism sheet 5. In FIG. 1, the numerous arrows indicate how light advances. The positive x direction in FIG. 2 is the direction in which light advances within light guide plate 3. The direction of the grooves formed in prism sheet 5 shown in FIG. 1 corresponds to the y direction in FIG. 2.

Liquid crystal display panel 6 includes a glass substrate 11 having a color filter layer 10 formed thereon, a glass substrate 7 having a TFT layer (not shown) formed thereon, and a liquid crystal layer 9 filling the space between glass substrates 11 and 7. Glass substrate 7 includes a permeable electrode (not shown) and a reflective electrode 8. Reflective electrode 8 is made of a metal film and has the property of shielding light from backlight 1. Further, reflective electrode 8 has periodically disposed apertures 12. Thus, the layer of reflective electrode 8 is a layer of shielding material with periodical apertures 12. The light from backlight 1 is transmitted through apertures 12 in reflective electrode 8, modified by liquid crystal layer 9, and emitter from viewing surface 13 of liquid crystal display panel 6. R, G and B in FIG. 2 indicate that their respective regions correspond to red, green and blue regions in color filter layer 10.

Reflective electrode 8 of liquid crystal display panel 6 is a periodical structure in which apertures 12 are arranged regularly, and may be called a “first periodical structure”. Prism sheet 5 is a periodical structure with a serrate cross section as shown in FIG. 1 and may be called a “second periodical structure”. When these two periodical structures are overlaid upon each other, moiré can be seen when viewed upon viewing surface 13 of liquid crystal panel 6.

As a general model, moiré produced by two periodical structures i.e. periodical structures A and B will be described. The pitch for periodical structure A is represented by P_{A} and the pitch for periodical structure B is represented by P_{B}. The spatial frequency for periodical structure A, f_{A}, is represented by a reciprocal of P_{A}. The spatial frequency for periodical structure B, f_{B}, is defined similarly. That is,
f_{A}=1/P_{A} (2)
f_{B}=1/P_{B} (3).
The periodical structure with spatial frequency f_{A} and the periodical structure with spatial frequency f_{B} are represented by:
g_{A}(x)=(1+cos(2πf_{A}x))/2 (4),
g_{B}(x)=(1+cos(2πf_{B}x))/2 (5).
Overlaying these two periodical structures gives:

$$\begin{matrix}gc ( x ) = {g}_{A} ( x ) \times {g}_{B} ( x ) \\ = ( 1 + cos ( 2 π {f}_{AX} ) ) \times ( 1 + cos ( 2 π {f}_{BX} ) ) / 4 \\ = \{ 1 + cos ( 2 π {f}_{AX} ) + cos ( 2 π {f}_{BX} ) \} / 4 + \\ \{ cos ( 2 π ( {f}_{A} + {f}_{B} ) x ) + cos ( 2 π ( {f}_{A} - {f}_{B} ) x ) \} / 8\end{matrix} \qquad ( 6 )$$

and presents terms with spatial frequencies f_{A} and f_{B} as well as additional components with spatial frequencies f_{A}+f_{B}, f_{A}−f_{B}. Particularly, components for light and dark with the frequency f_{A}−f_{B} can be conspicuous because of the low frequency. Such light and dark in frequency components are called moiré. On the other hand, components with the frequency f_{A}+f_{B} have higher frequency than f_{A} and f_{B} and have very high frequencies when P_{A} or P_{B} is sufficiently small, and thus they cannot be seen.

Now, moiré from a layer of light-shielding material, which is a transmissive liquid crystal display panel including transmissive apertures with aperture pitch P_{L} and aperture width W_{L}, and a prism sheet of prism pitch P_{P} will be discussed. The transmissitivity profile T_{F} (x) of a transmissive liquid crystal display panel is given by the following equations, using a Fourier series expansion. Here, n is a natural number.
T_{F}(x)=Aₒ/2+ΣAₙ cos(2πnf_{L}x) (7)
f_{L}=1/P_{L} (8)
Aₙ=2W_{L}/P_{L} (9)
Aₙ=2W_{L}/P_{L}·sin(nπW_{L}/P_{L})/(nπW_{L}/P_{L}) (10)

The above equations demonstrate that Aₙ obeys a sinc function. Aₙ is determined by the relationship between W_{L} and P_{L}.

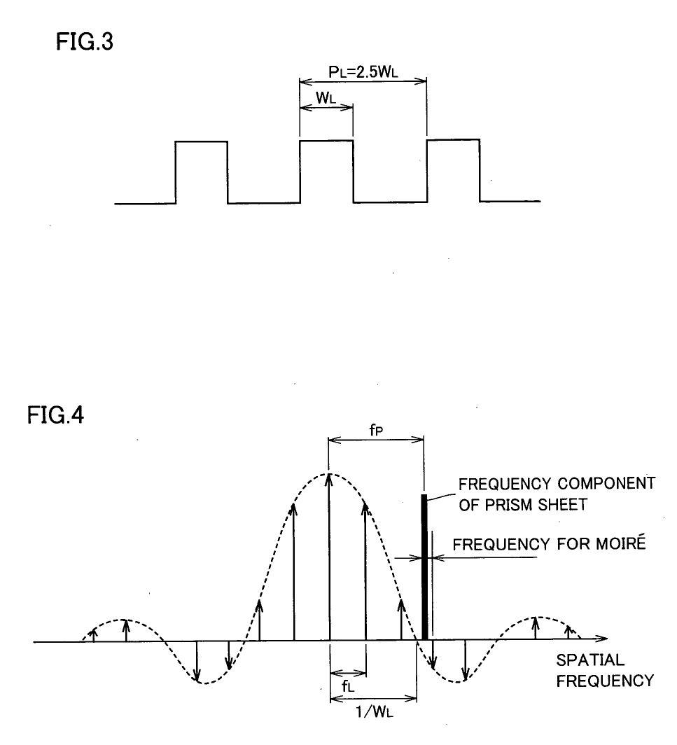

FIG. 3 shows an exemplary transmissivity profile T_{F} (x). FIG. 4 illustrates corresponding spatial frequency components. The lateral axis indicates the spatial frequency, while the vertical axis indicates the magnitude of the components. FIGS. 3 and 4 show results for P_{L}=2.5 W_{L}.

The outgoing light from a prism sheet of prism pitch P_{P} is represented by:
I(x)=(1+cos(2πf_{P}x))/2 (11)
f_{P}=1/P_{P} (12)

When the light from the prism sheet enters the liquid crystal display panel and exits from the viewing surface, this outgoing light from the viewing surface, O(x), is given by:
O(x)=I(x)×T_{F}(x) (13).
O(x) contains a variety of components of spatial frequency, as derived from the results of equation (6), of which the components of the lowest frequencies are visible as moiré. When spatial frequency F_{P} of the light exiting the prism sheet is close to n×f_{L}, moiré occurs between spatial frequency f_{P} and nf_{L}, and a reciprocal of f_{P}−nf_{L} is the period of moiré.

The condition in which f_{P} is close to nf_{L} is given by:
nf−f_{L}/2<f_{P}<nf_{L}+f_{L}/2 (14).

Since under this condition, f_{P}−nf_{L} is the smallest of the various spatial frequencies, moiré of this spatial frequency is particularly conspicuous. However, decreasing one of the frequency components provides the ability to reduce moiré contrast. Consider decreasing the component of spatial frequency nf_{L}. Moiré contrast can be significantly reduced by setting to zero the spatial frequency component of nf_{L} of transmissitivity T_{F} (x) of a pixel aperture panel while satisfying equation (14). To provide a condition in which component Aₙ of spatial frequency nf_{L} is zero, from equation (10),
W_{L}/P_{L}=m/n (m is a natural number) (15)
is derived. That is, for
nW_{L}=mP_{L} (16),
Aₙ is 0. Further, using P_{L} and P_{P}, equation (14) is represented as:
(2n−1)/(2·P_{L})<1/P_{P}<(2 n+1)/(2·P_{L}) (17).

To summarize the above-described relationships, where
nW_{L}=mP_{L} (m and n are natural numbers) and
(2n−1)/(2·P_{L})<1/P_{P}<(2n+1)/(2·P_{L}),
   Moiré contrast can be effectively reduced.

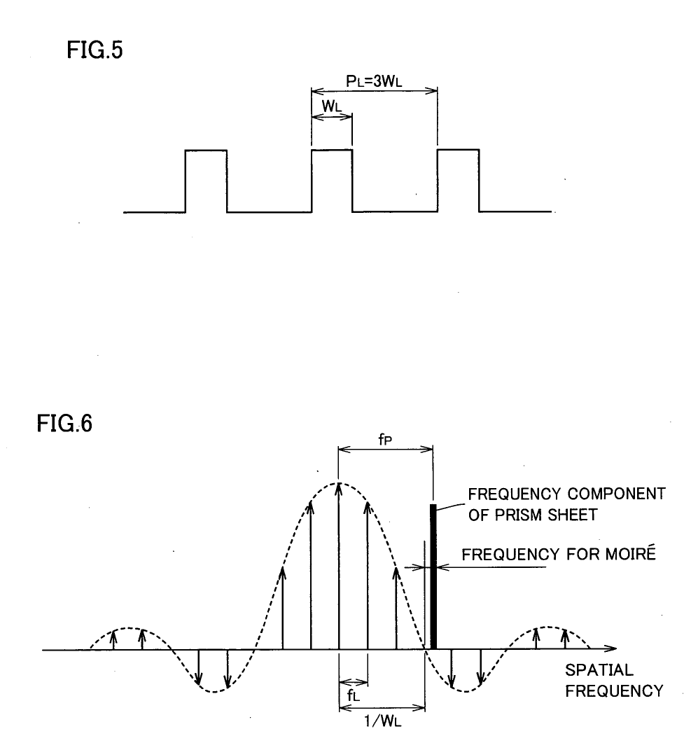

These relationships will be described with reference to FIGS. 5 and 6. FIGS. 5 and 6 illustrate, in a representation similar to FIGS. 3 and 4, transmissitivity profile T_{F} (x) and its spatial frequency components for P_{L}=3W_{L}. Here, since the spatial frequency of a prism sheet is close to 3×f_{L} and the component value for 3×f_{L} is zero, there is low moirécontrast.

It should be noted that although it is preferable that the condition nW_{L}=mP_{L} is satisfied, it needs not be exactly satisfied. Moiré contrast can be significantly reduced if the value of Aₙ is not more than 0.05 while satisfying equation (17), even when Aₙ is not zero.

To design a liquid crystal display panel, the aperture pitch for each pixel is uniquely defined by the panel size and the resolution. Also, the flexibility in choosing a prism pitch of a prism sheet is small because there are currently only a few types of prism sheets that are commercially available. On the contrary, the present invention allows a condition to be derived that effectively reduces moiré contrast for any aperture pitch, any prism pitch and any pixel aperture ratio. In this case, there is no flexibility for the aperture width for each pixel, although the lack of flexibility in the aperture width does not present a significant limitation in the designing of a liquid crystal display panel. Further, according to the present invention, the crossing angle can take any value, thereby allowing the crossing angle of a liquid crystal display panel and a prism sheet to be 0, enabling maintaining a high front brightness.

A practical embodiment will now be described.

### Example 1

Moiré contrast was investigated for the following conditions:

| | |
|---|---|
| Prism sheet pitch P_{P}: | 30 μm |
| Aperture pitch for each pixel P_{L}: | 150 μm |
| Aperture width for each pixel W_{L}: | 60 μm |

In this case, basic spatial frequencies f_{L} and f_{P} for a pixel aperture panel (layer of shielding material) and a prism sheet are determined as follows:

| | |
|---|---|
| f_{P} = 33.33 | [per mm] |
| f_{L} = 6.67 | [per mm] |

and thus satisfy the relationship in equation (17) for n=5. It also satisfies equation (16) for m=1. Here, moiré was not visible.

On the contrary, when moiré is to be reduced according to the conventional art by crossing the arrangements of a pixel aperture panel and a prism sheet, crossing angle θ is determined as 25.8° from equation (1). When crossing angle θ was actually made 25.8°, which is a very large crossing angle θ, the front brightness was significantly decreased.

This means that while the conventional art reduces moiré by increasing crossing angle θ which necessitates a decrease in the front brightness, the present invention does not require crossing angle θ to be altered, thereby allowing the reduction of moiré without decreasing the front brightness.

### Comparative Example 1

Moiré contrast was investigated for the following conditions:

| | |
|---|---|
| Prism sheet pitch P_{P}: | 30 μm |
| Aperture pitch for each pixel P_{L}: | 150 μm |
| Aperture width for each pixel W_{L}: | 70 μm |

In this case, similar to embodiment 1, basic spatial frequencies f_{L} and f_{P} for a pixel aperture panel (a layer of light shielding material) and a prism sheet are determined as follows:

| | |
|---|---|
| f_{P} = 33.33 | [per mm] |
| f_{L} = 6.67 | [per mm] |

and satisfy the relationship in equation (17) for n=5. However, since there exists no natural number m that satisfies the relationship in equation (16), Aₙ is 0.1 i.e. a value larger than 0.05. Here, moiré was particularly visible.

The above demonstrates that moiré may not be reduced for Aₙ greater than 0.05 even when equation (17) is satisfied.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A liquid crystal display device, comprising:
a first periodical structure which is a layer of light shielding material having periodical apertures; and
a second periodical structure,
wherein Aₙ determined by
Aₙ=2W_{L}/P_{L}·sin(nπW_{L}/P_{L})/(nπW_{L}/P_{L}) (n is a natural number) is not more than 0.05 and
(2n−1)/(2·P_{L})<1/P_{P}<(2n+1)/(2 ·P_{L})
is satisfied, where P_{L} and W_{L} are the pitch and width of said apertures, respectively, and P_{P} is the pitch of said second periodical structure.

2. A liquid crystal display device, comprising:
a first periodical structure which is a layer of light shielding material having periodical apertures; and
a second periodical structure, wherein
nW_{L}=MP_{L} (m and n are natural numbers) and
(2n−1)/(2·P_{L})<1/P_{P}<(2n+1)/(2 ·P_{L})
is satisfied, where P_{L} and W_{L} are the pitch and width of said apertures, respectively, and P_{P} is the pitch of said second periodical structure.
